(19) United States
(12) Patent Application Publication
(10) Pub. No.: US 2011/0061597 A1
(43) Pub. Date: Mar. 17, 2011

(54) Protected Squirrel Feeder

(76) Inventor: John E. Ehrreich, Marstons Mills, MA (US)

(21) Appl. No.: 12/905,597

(22) Filed: Oct. 15, 2010

Related U.S. Application Data
(63) Continuation-in-part of application No. 12/079,669, filed on Mar. 29, 2008.

(51) Int. Cl. A01K 5/00

(52) U.S. Cl. 119/57.9

(57) ABSTRACT

A protected feeder is provided for squirrels which comprises a feeder having a self supporting enclosure for predator protection from hawks or foxes to be positioned adjacent a tree for providing a protected perch with access openings in the cover and a selected portion of ground therein is covered with food. The enclosure member is substantially impervious and protects the squirrels while feeding and protects the squirrel from weather. This invention provides various designs for the protected squirrel feeder adapted to protect the food, one using a tray which is smaller than the self supporting enclosure and a second feeder uses small high-calcium loaded rocks as a ground layer.

### CROSS-REFERENCE TO RELATED APPLICATIONS

This utility patent application is a continuation-in-part of U.S. patent application Ser. No. 12/079,669, filed Mar. 29, 2008, titled “Protected Squirrel Feeder” in the name of John E. Ehrreich.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2010, John Ehrreich.

### BACKGROUND OF THE INVENTION

1. Field of the Invention

A protected feeder is provided for squirrels which comprises a feeder having a self supporting enclosure. The enclosure member acts as a cover providing for predator protection from hawks or foxes, is provided with a plurality of openings in it and includes a selected portion of ground under the enclosure covered with food for squirrels. The enclosure member is substantially impervious and protects the squirrel while feeding from predators as well as protects the squirrel from weather as well as provides a means of escape. This invention provides various designs for the protected squirrel feeder adapted to cover the food; in one case using a tray which is smaller than the self supporting enclosure and in a second case a second feeder uses small high calcium loaded rocks as a ground layer.

2. Background Prior Art

Applicant is aware of prior art squirrel feeders. For example the following four U.S. patents relate to squirrel feeders; U.S. Pat. No. 5,467,736 to Reynolds relates to a wild animal feed dispensing machine; U.S. Pat. No. 6,334,407 to Schneider relates to an enclosed indoor feeding compartment which allows indoor viewing; and U.S. Pat. No. 5,664,522 to Keller relates to a squirrel or small feeding apparatus comprising a mounting post, an angular member and a pivot arm.

It is noted though that these patents are primarily directed to feeding squirrels, none of them take into account the need to provide predator protection for the squirrels who are attracted to these feeders. In particular, though these patents are directed to feeding squirrels, none of them take into account the need of a one piece molded plastic enclosure that; (1) acts as a cover providing for predator protection; (2) protects the squirrel food from the bad weather; (3) hides a feeding squirrel from predators; (4) allows for quick exiting when necessary; (5) allows for locating the enclosure near (adjacent) trees, brushes, and/or tall grasses; and/or (6) allows for “color blending into the environment” by including coloring of the outer enclosure surface such as camouflaging wherein patterns including figures or shapes; and/or color modifying for aesthetics are employed; because while on the ground squirrels are vulnerable to more types of predators than in the trees, but since much of their food supply is on the ground they find it necessary to search the ground. Accordingly it is important to provide additional protection for the feeder in the form of color blending into the environment and under special situations allowing for the use of one-way mirror in the form of “windows and/or one-way windows and/or exits to watch for exterior threats. The American Heritage Dictionary of the English Language: Fourth Edition. (a mirror that is reflective on one side and transparent on the other, often used in surveillance.

Applicant is also aware of prior art bird feeders and in particular to U.S. Pat. No. 6,321,686, to Geis; et. al directed to a multipurpose species discriminating bird feeder for controlling ingress and egress of birds into interior of a bird feeder. However having reviewed Geis; et al. applicant's view is the Geis; et al. claims do not read on applicant's for the reason that Geis is directed to arranging a bird feeder on a tree with little openings limiting access for little birds. Unlike Geis applicant's squirrel feeder is directed to providing a protective barrier on the ground having means for quick escape in addition to controlled access for squirrels adjacent a protective roost in a tree.

Squirrels are at home not only in trees but spend much of their time searching for food on the ground; such as pine cones, nuts, acorns, corn, berries, seeds, bulbs, etc., while at the same time they bury much of the food in the ground. While on the ground squirrels are vulnerable to more types of predators, particularly hawks or foxes, than in the trees, but since much of their food supply is on the ground they find it necessary to search the ground. Food source areas are so searched out by squirrels, that when they discover an area they often develop pathways to it. These pathways aid young squirrels in traveling to and from the food supply

Accordingly, it is desirable to provide for a new and improved feeder for squirrels and in particular to a feeder that provides for protection from predator hawks and foxes. More particularly to a feeder housing comprising a self supporting enclosure, having multiple openings for ingress and egress, the enclosure in the form of a molded dome being operable in connection with the ground to be positioned on the ground within six feet from a tree, wherein the molded dome employs the ground as a floor for use with the food; which overcomes at least some of the disadvantages of prior art.

### BRIEF SUMMARY OF THE INVENTION

The present invention is directed to providing a shielded squirrel feeder. More specifically the present invention is directed to a shielded squirrel feeder comprising a one piece molded plastic enclosure that protects the squirrel food from the bad weather; hides a feeding squirrel from predators; allows for quick exiting when necessary; allows for locating the enclosure near trees providing a protective roost; color blending into the environment; and under special situations allowing for the use of one way windows and/or exits to watch for exterior threats.

In particular this invention provides a feeder for a squirrel having a self supporting enclosure comprising a molded dome that aids in the protection from predators such as hawks or foxes. Protection is in the form of a protective cover for food to be positioned on the ground spaced six feet from a protective roost comprising a tree. More specifically it relates to an arrangement of a feeder for a squirrel with an enclosure, having multiple openings providing ease of access and exit for a squirrel, the feeder being operable on the ground, wherein the molded dome employs the ground as a bottom for use with food placed on it. The feeder is attached to the ground with stakes. To control the food area within the molded enclosure, a tray may be used. The protective cover member can include a marginal portion which extends substantially beyond the edges of the food area and under special situations allowing for the use of one way windows and/or exits to watch for exterior threats. One Way windows are particularly effective for blocking view of a within contained squirrel.

The squirrel feeder is easily filled or replenished with a scoop The squirrel feeder has a substantially impervious enclosure member; which is economical to manufacture, efficient in use, capable of a long operating life, and particularly well adapted for the proposed use thereof. To control the food area within the molded enclosure, a tray may be used. A second way of VT 05764). These stones tend to keep the adjacent ground more neutral if it was acidic, protecting the food supply in the feeder from fungus is that of using a layer of small high calcium loaded rocks such as ⅝ inch minus Marble Stone (Western State, Inc. of Poultney, reducing the chance for fungus growth and may supply calcium needs for the squirrel. To fix the molded enclosure to the ground, stakes may be used.

A specialized design of the invention employs a plastic dome with an opening on one end which is used by a squirrel for ingress or egress. Part of this specialized design involves a second opening on the upper surface near the opposite end which is covered by an attached flexible cover and can be used by the internal squirrel to escape when necessary. In using this design, the ingress/or egress opening is often used close to a tree to allow the squirrel to escape on the tree and to minimize the entrance of the feeder by birds. When the feeder is used near a tree, the ingress/or egress opening is often less than 12 inches from the tree and a preferred positions less than 6 inches. The flexible cover over the egress opening on the top protects the internal food from the weather, reduces the ease by which any external animal can enter the feeder and allows light into the feeder for the benefit of the internal squirrel.

More particularly, it is an object of the invention to provide a self supporting enclosure comprising a molded dome providing protection for squirrels from predators such as hawks or foxes while feeding by hiding a feeding squirrel from predators; allows for quick exiting when necessary; and allows for locating the enclosure near trees providing a protective roost.

Other objects and advantages of this invention will become apparent from the following descriptions taken in conjunction with the accompanying drawings wherein are set forth by way of illustration and example, certain embodiments of this invention.

The invention will be described for the purposes of illustration only in connection with certain embodiments; however, it is recognized that those persons skilled in the art may make various changes, modifications, improvements and additions on the illustrated embodiments all without departing from the spirit and scope of the invention.

### BRIEF DESCRIPTION OF THE DRAWINGS

For a better understanding of the present invention, reference may be had to the following detailed description taken in conjunction with the accompanying drawings in which feeders for squirrels having a self supporting enclosure comprising a molded dome providing protection from predators such as hawks.

FIG. 1 is a side view of a detached squirrel feeder employing a plastic protective dome providing an enclosure for an enclosed portion of squirrel food incorporating at least two side openings for quick escape wherein at least one of these holes can be used for access into the feeder; the feeder shown positioned adjacent a tree.

FIG. 2 is a side view of the detached squirrel feeder of FIG. 1 positioned adjacent a tree where an opening employed for quick escape is located at the top of the feeder is shown employing a flexible cover.

FIG. 3 is a side view of the detached squirrel feeder of FIG. 1 employing a plastic protective dome fastened to the ground by stakes, incorporating at least two side openings for quick escape wherein at least one of these holes can be used for access into the feeder and a pile of feed that is deposited on the ground, shown in dashed lines, providing for access and escape for a squirrel also shown in dashed lines.

FIG. 4 a side view of an alternative embodiment of the detached squirrel feeder of FIG. 3 employing a plastic protective dome fastened to the ground by stakes, incorporating at least two side openings with protective collars for quick escape with an exterior pattern of coloring agents employing leaves in with an in accordance with an alternate embodiment of the invention.

FIG. 5 is a side view of the squirrel feeder of FIG. 3 with an alternate exterior pattern of coloring agents employing flowers;

FIG. 6 is a side view of the squirrel feeder of FIG. 3 shown with a squirrel shown entering a side opening with a second alternate exterior pattern of coloring agents employing ivy vines.

FIG. 7 is an alternate view of the squirrel feeder of FIG. 2 showing the flexible cover over the top escape with a protective flap over the top escape opening including a cushion wherein the flexible cover is fastened by multiple staples over the top escape.

FIG. 8 is a side view of the squirrel feeder of FIG. 1 shown in combination with a floor supporting a layer of high calcium load small rocks that are deposited on the floor.

FIG. 9 is a side view of squirrel feeder having additional protection under special situations allowing for the use of one way windows and/or exits to watch for exterior threats with an in accordance alternate embodiment of the invention.

FIG. 10 is an end view of the squirrel feeder showing use of partial light blocking coating on film strips covering an opening that allows the squirrel to see an exterior predator and not to be seen by the predator.

FIG. 11 is a view of the squirrel feeder in a round dome configuration.

FIG. 12 is a side view of the squirrel feeder of FIG. 11 shown in combination with a floor.

### DETAILED DESCRIPTION OF THE INVENTION, INCLUDING THE PREFERRED EMBODIMENT

As required, detailed embodiments of the present invention are disclosed herein. However, it is to be understood that the disclosed embodiments are merely exemplary of the invention which may be embodied in various forms. Therefore, specific structural and functional details disclosed herein are not to be interpreted as limiting but merely as a basis for the claims and as a representative basis for teaching one skilled in the art to variously employ the present invention in virtually any appropriately detailed structure.

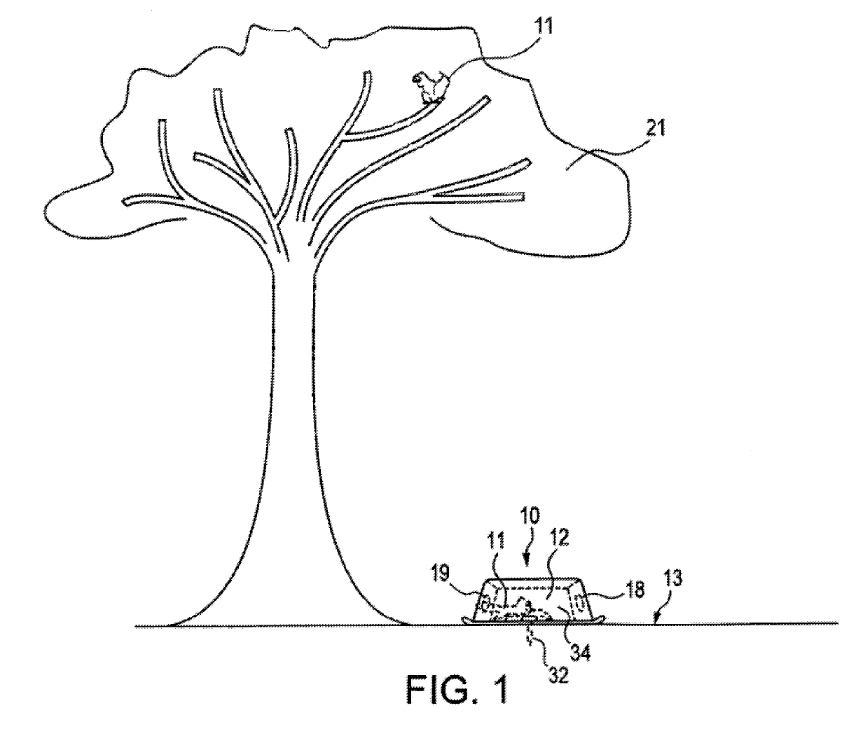

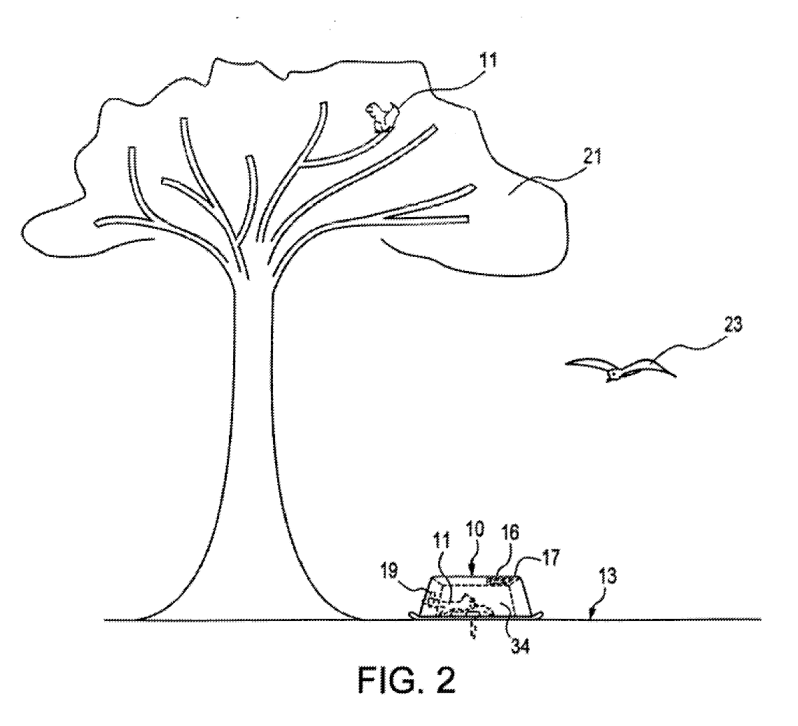

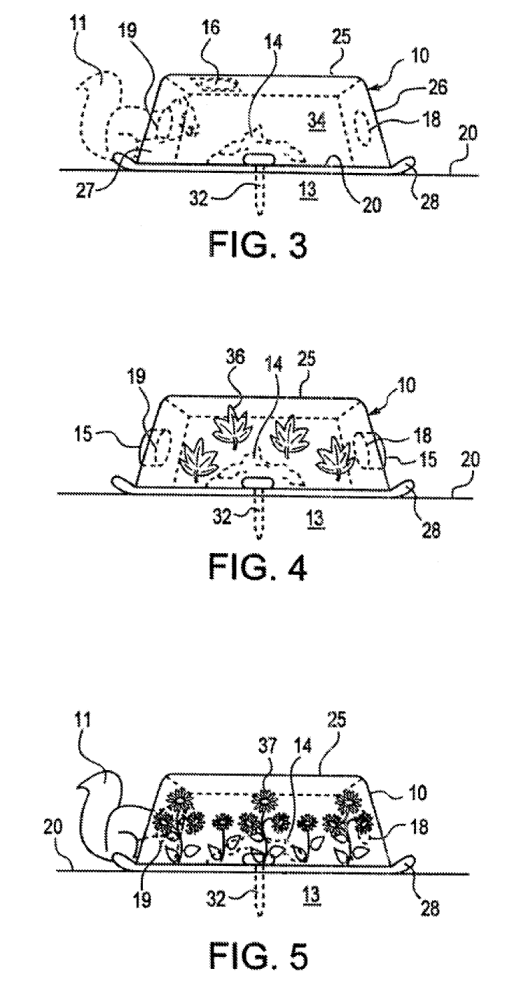

Referring to the drawings in more detail: in the first, preferred embodiment of the present invention as illustrated in FIGS. 1, 2 & 3 the reference numeral 10 generally designates a protected feeder for one or more a squirrels shown as 11 which employs a molded plastic enclosure 12. In particular, referring now to the FIG. 1, there is shown a perspective view of a preferred embodiment of a squirrel feeder 10 located adjacent a tree 21 with a squirrel 11 in the tree in accordance with the present invention. The juxtaposition of these three elements is to emphasize that for the squirrel feeder 10 to operate most effectively it needs to be located adjacent a tree 21 to provide protection for the squirrel 11. The molded plastic enclosure 12 as is shown in FIG. 3 provides a one piece molded plastic enclosure including a front wall 26 having side access opening 18, a back wall 27 having a side access opening 19, and a rim 28 that cooperates with stakes 32. The stakes 32 are employed to fix the enclosure 12 to the ground 13. Additional structural members comprises a first side wall 34 and a second side wall 35, of thin-wall construction, having a bottom opening 29 to the ground shown in FIG. 8 that defines the bottom of the said squirrel feeder 10. An optional additional member comprises a tray 30 employed as a floor that extends horizontally between said front wall 26 and back wall 27 arranged in orthogonal relationship thereto wherein the tray 30 is employed for holding squirrel feed 14 distributed on top of a layer of calcium loaded small rocks 31.

As is shown in FIG. 1, feeder 10 includes at least two access openings including at least two uniquely identified and separately located access openings 18 and 19, either of which permit quick exiting by a squirrel 11. The one piece molded plastic enclosure 12 is designed to (a) protect the feed 14, shown spread on the ground shown with dotted lines under feeder 10, from scavenging birds as well as bad weather; (b) hide the squirrel 11 from predators such as hawks 23 (c) allow for quick and safe exiting from the feeder 10 when necessary; and (d) allow for locating the feeder 10 near trees 21. Referring to FIG. 1 there is shown is a side view of squirrel feeder 10 that is shown positioned adjacent a tree 21 in accordance with the present invention.

Referring to FIGS. 2, 7 & 8, there is shown the top escape opening 16 which includes an upper protective flexible cover 17 positioned over a top escape opening 16 as is shown in FIG. 7 that allows a within-contained feeding squirrel 11 to escape, and if necessary also keeps out the rain. As is shown in FIG. 7 a flexible cover 17 is shown acting as a protective flap 41 positioned over the top opening 16. The protective flap 41 is fastened by means of multiple staples 42 to the plastic dome 12.

As is previously indicated in FIGS. 1-3, the preferred embodiment of the invention is shown employing the plastic enclosure 12 having multiple openings 18 & 19 being directed to providing for access and/or alternatively exit means for a squirrel 11 using the squirrel feeder 10. As is shown in FIG. 3 there is shown a side view of squirrel feeder 10 the feeder 10 includes three openings including at least two uniquely identified and separately located access and exit openings 18 and 19, either of which permit quick exiting by a squirrel 11 entering the squirrel feeder 10 shown in dashed lines. FIG. 2 shows the of squirrel feeder design is one that helps to keep out birds seeking feed as well as other animals and consists of (a) a plastic dome 12 forming an enclosure with an entrance opening 19, spaced 5 inches from the base of a tree 21; (b) a top opening 17 located on the upper surface of the dome 12 and (c) a top flexible cover 16 that allows the within-contained feeding squirrel 11 to escape when necessary and also keeps out the rain. As is shown in FIG. 2, the preferred embodiment employs a top flexible cover 17 that includes a flap 41 that over laps the escape opening 16 which is located in the dome 12 adjacent tree 21. As is shown in FIG. 7 there are staples 42 to keep plastic film 44 to keep it held down. Escape through the back opening 19 is 3″ to 5″ in diameter. The top of the dome 12 includes the front opening 18 positioned at the opposite end of the dome having a hole of similar size. The flap 41 is 5 mil thickness, and comprises a flexible mylar sheet 4″ to 7″ as shown in FIG. 7.

As is shown in FIG. 8 to control the food area 24 within the molded enclosure 12, a tray 30 may be used. Also to fix the plastic dome to the ground, stakes 32 may be used as is shown in FIG. 3. Also as is shown in FIG. 8 tray 30 extends horizontally between said front wall 26 and back wall 27 arranged in orthogonal relationship thereto.

Squirrels 11 are at home not only in trees as shown in FIG. 1, but spend much of their time searching for food on the ground; such as acorns, pine cones, corn, berries, seeds, bulbs, etc., while at the same time they bury much of the food in the ground. While on the ground squirrels are vulnerable to more types of predators than in the trees, but since much of their food supply is on the ground they find it necessary to search the ground. Accordingly it is important to provide additional protection for the feeder 10 in the form of color blending into the environment shown in FIGS. 4, 5, and 6.

The FIGS. 4, 5 & 6 generally represents additional embodiments of the invention employing additional protection for the feeder 10 in the form of color blending into the environment. The color blending is accomplished by creating selected exterior patterns of coloring agents, such as leaves, blossoms or vines such as ivy, applied by stenciling, spraying, transfer printing, labeling, brushing, stamping or a combination thereof. Referring to FIG. 4 there is shown a first alternate embodiment of color blending of the plastic enclosure 25 into the environment which employing exterior patterns of leaves 36. An additional feature of this embodiment is that sleeves 52 provided on openings 18 and 19 for added protection.

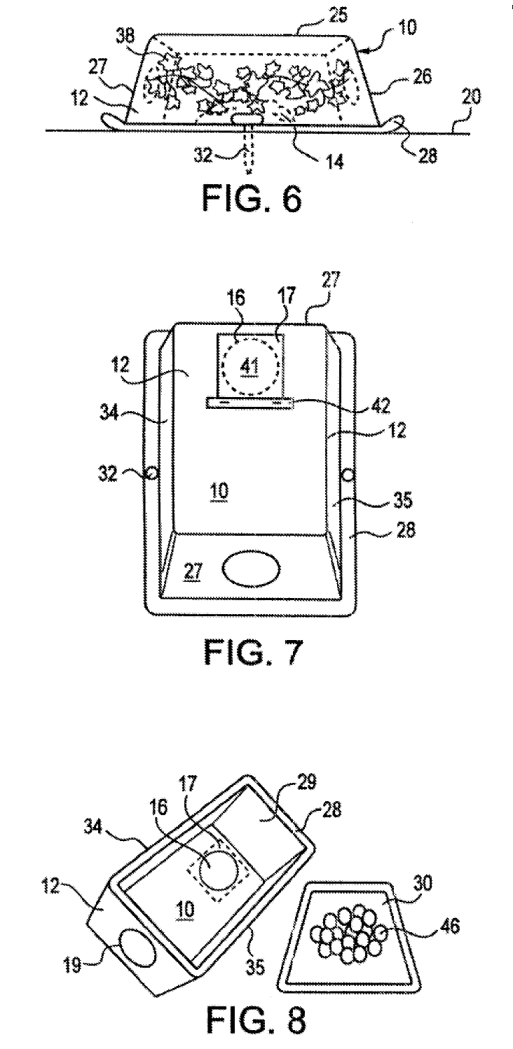

Turning to FIG. 5 there is shown a side view of squirrel feeder 10 and squirrel 11 entering the squirrel feeder 10 shown in dashed lines and with an exterior pattern of coloring agents 37 in the form of exterior patterns of multiple flowers shown on the exterior of dome 10 with an in accordance with a second alternate embodiment of the invention Referring to FIG. 6 there is shown a third alternate embodiment of color blending which employs exterior patterns of ivy vines plastic enclosure 25 into the environment which employs ivy vines 38.

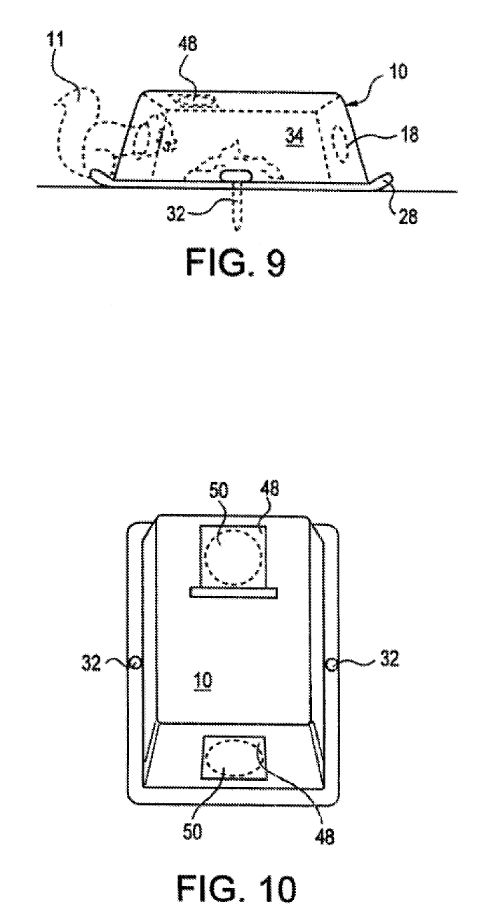

Also as seen in FIGS. 9 and 10 additional protection is provided under special situations allowing for the use of one way windows 48 and/or exits to watch for exterior threats, and under special situations allowing for the use of a partial light blocking coating on film strips 60 covering an opening that allows the squirrel to see an exterior predator and not to be seen by the predator.

Yet another (fourth) variation to protect the food and/or in some cases protect the squirrel involves coating containing an insect repellent and or anti microbial agents. The preferred rock sizes are minus ⅝ inch in one direction.

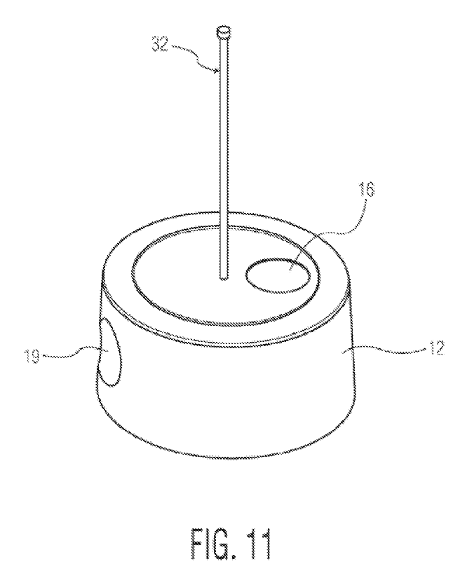

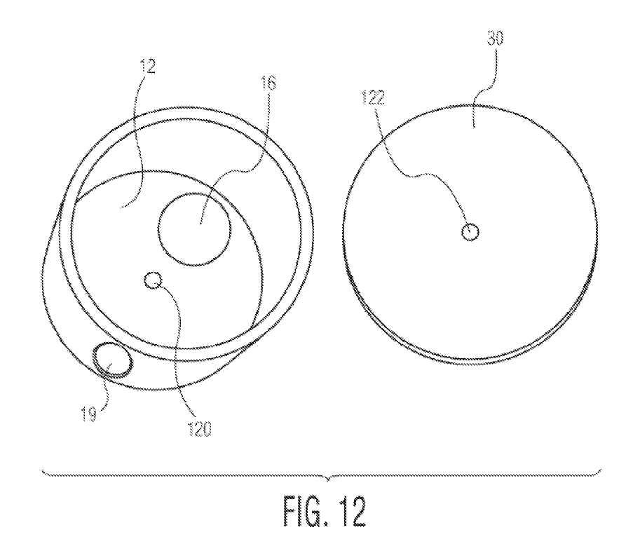

An alternate variation, as shown in FIGS. 11 and 12, utilizes a circular enclosure 12. This allows using a single stake 32 passing through both enclosure 12 and plate 30. The single, centered stake adds the benefit of staking both the enclosure and the plate, reduces the number of stakes needed to one, and can further serve as a visible indicator by extending to any arbitrary height. Some stronger animals, such as raccoons, are able to vertically flip oblong enclosures with two edge stakes. Using a centered stake prevents such vertical flipping, however some animals are then able to spin an oblong enclosure on the stake. This rotation may expose food or anything else stored within the enclosure. By making enclosure 12 circular, spinning on centered stake 12 does not risk uncovering the contents within. Stake 12 may be offset from perfect center, however if not centered exposure of covered contents by rotation of enclosure 12 may be possible. If such is rotation is occurring, driving a second stake through the top of enclosure 12 and into the ground may prevent further rotation, but again involves the second stake. Enclosure 12 may still have entry 19, vertical exit 16, with other features and options as previously discussed.

Stake 32 may be a single piece stake or multiple pieces connected to form a single stake. Multiple pieces allows for easier packaging for shipping the product, and also allows for various stake heights. Stake 32 may be driven into the ground sufficient to hold when pushed and prodded by animals. Sufficient depth may vary with the location and composition of the ground. For example, driven into soft soil may require a depth of less than six inches or up to three feet or more to hold securely. However driven into a tree root may require only a couple inches to be secure. In addition to soil and physical environment considerations, sufficient depth may vary based on the wildlife in the environment. With only squirrels and no predators of concern, minimal depth to secure the stake may be sufficient. With concern of stronger animals, such as raccoons, deeper depths to more sufficiently secure the stake may be desire.

Once driven into the ground, a clamp, nut, or other blocking attachment may be connected to stake 32 above the top of enclosure 12 to secure the enclosure and prevent the enclosure from being lifted off the ground by animals. The clamp must secure to stake 32 and be sized to not fit through the stake hole in enclosure 12. It is also preferable for the clamp to have an easy method of removal for a person to detach in order to quickly refill food or otherwise access the enclosure, yet not be so simple that an animal can easily open or knock off the clamp. As stake 32 passes through holes 120 and 122 in enclosure 12 and plate 30, a nut or clamp sized to cover and block hole 120 may also help keep rain from entering.

It is foreseen that although various cover members have been disclosed herein, other shapes such as rectangular or square receptacles and/or covers could be utilized according to the present invention. A variety of configurations of the present invention may thereby be employed to satisfy the needs of squirrels under different feeding conditions.

It is to be understood that while certain forms of the present invention have been described and illustrated, it is not to be limited to the specific forms or arrangements of parts herein described and shown.

1. A detached squirrel feeder comprising:
a housing means comprising a circular dome enclosure providing a protective barrier for the enclosed squirrel food;
multiple exit holes comprising at least two openings for quick escape and at least one of these holes can be used for access into the feeder;
a means for anchoring the feeder to the ground; and
ability to hide the squirrel from its enemies.

2. A detached squirrel feeder comprising:
a housing means comprising an enclosure providing a protective barrier for the enclosed squirrel food;
multiple exit holes comprising at least two openings for quick escape and at least one of these holes can be used for access into the feeder;
a single stake through the housing means for anchoring the feeder to the ground; and
ability to hide the squirrel from its enemies.

3. A detached squirrel feeder comprising:
a plastic circular dome with a vertical side extending from the ground up to a mostly flat top surface, with at least one entrance in the vertical side and at least one flexible covered opening located on the top surface of the dome.

4. The squirrel feeder of claim 3, further comprising a flat circular plate which fits under the vertical side creating a bottom floor under the circular dome.

5. The squirrel feeder of claim 3, further comprising a central stake through the center of the top surface of the dome, wherein the central stake extends into the ground to hold the squirrel feeder in place.

6. The squirrel feeder of claim 4, further comprising a stake through the top surface of the dome and the center of the circular plate, wherein the stake extends into the ground to hold the feeder in place.

7. The squirrel feeder of claim 6, wherein the stake is positioned through the center of the top surface of the dome.

8. The squirrel feeder of claim 6, further comprising a clamp connected to the central stake immediately above the top surface of the dome such that the clamp prevents the dome from raising off the ground.
